(19) United States
(12) Patent Application Publication
(10) Pub. No.: US 2003/0028293 A1
(43) Pub. Date: Feb. 6, 2003

(54) Sea surveillance method

(76) Inventors: Christian Jankowiak, St Exupery (FR); Gilles Coppin, rue de la Marne (FR); Jean-Luc Voirin, rue Vasco de Gama (FR)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/148,899

(22) PCT Filed: Dec. 15, 2000
(86) PCT No.: PCT/FR00/03561

(30) Foreign Application Priority Data
Dec. 21, 1999 (FR) 99/16165

(51) Int. Cl. G05D 1/00

(52) U.S. Cl. 701/21

(57) ABSTRACT

The present invention relates to a method and a device for maritime surveillance. The method includes at least:

a first stage (101) of the periodic gathering of maritime-traffic information by cooperating ships (NC, NC1, NC2, NC3) passing through the surveillance area (21), on the basis of their navigation equipment, the ships sending the information to a main maritime-surveillance center (29);

a second stage of managing the overall traffic situation carried out by the main center on the basis of the data gathered by the cooperating ships, each ship thus providing a local traffic situation.

The invention also includes a device for implementing the method.

The invention applies especially in the context of maritime control and surveillance in order to enhance the safety of the traffic.

The present invention relates to a method and a device for maritime surveillance. It applies especially in the context of maritime monitoring and surveillance in order to enhance the safety of the traffic.

In order to enhance the safety of the maritime traffic, it is especially necessary to comply with the rules of navigation and to have them complied with by the users. It is also necessary to supply the navigators and the surveillance and monitoring authorities with the information and tools allowing for better navigation.

Radar images, electronic mapping, satellite-positioning systems, telecommunications facilities on board the ships and in the land-based centers are the tools generally used by navigators and controllers. These tools, which are particularly elements of systems for integrated management of the maritime and port traffic, exhibit certain drawbacks.

A first series of drawbacks lies in the fact that the radar field of view of the controllers in the centers on land is limited. Each area of surveillance by the centers on land is limited to the area of coverage of the radar facilities on the ground. By way of example, in the case of the English Channel, the existence of only a first center at Brest, of a second one at Jobourg and of a third at Calais means a lack of knowledge of the traffic existing outside their immediate perimeters. This results particularly, outside these perimeters, in:

difficulty in organizing help quickly from ships present in the area;

absence of detection and/or of anticipation of hazardous situations;

a lack of continuous tracking of the traffic;

absence of prediction of the traffic over the whole of the area to be surveyed;

a lack of knowledge of the position of the ships.

Other drawbacks lie in the fact that small ships are not equipped with radar and have only visual knowledge of the traffic in their navigation areas. This is manifested especially by:

absence of detection and/or of anticipation of hazardous situations by the users themselves;

absence of collective monitoring of navigation.

One object of the invention is especially to remedy all of these drawbacks. To this end, the subject of the invention is a method of surveillance of maritime traffic, which includes at least:

a first stage of the periodic gathering of maritime-traffic information by cooperating ships passing through the surveillance area on the basis of their navigation equipment, the ships sending the information to a main maritime-surveillance center;

a second stage of managing the overall traffic situation carried out by the main center on the basis of the data gathered by the cooperating ships, each ship thus providing a local traffic situation.

A further subject of the invention is a device for implementing the method.

The invention particularly has the main advantages that it increases the capabilities for monitoring maritime traffic, that it allows better optimization of the commercial investments by better navigation, that it allows tracking of ships deliberately wishing to remain discreet, that it provides the ships with a dedicated channel for raising personalized alarms originating from a land-based center, and that it makes it possible to cover a wide maritime expanse economically.

Other characteristics and advantages of the invention will become apparent with the aid of the description which follows, given with regard to attached to drawings which represent:

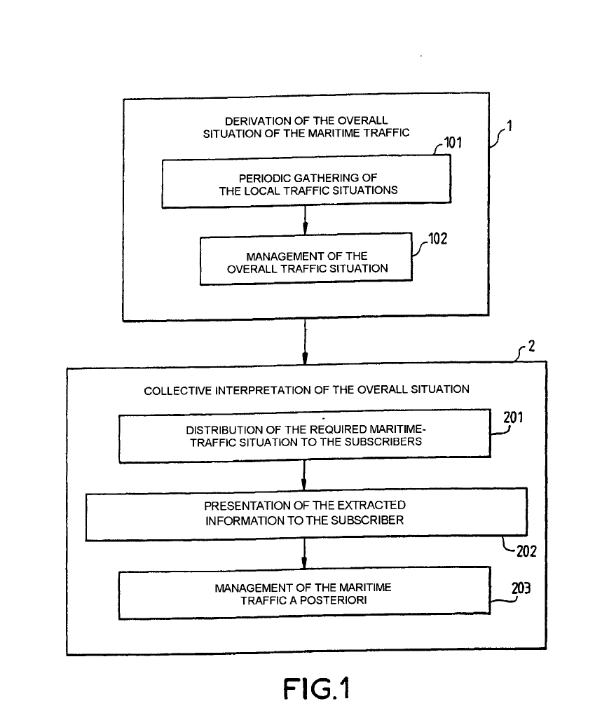

FIG. 1, the possible stages of a method according to the invention;

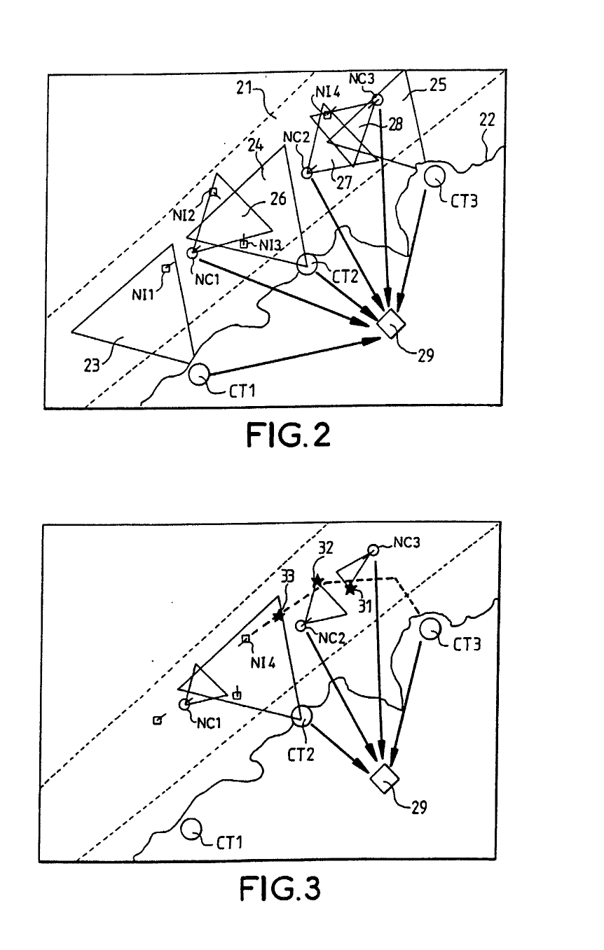

FIG. 2, an example situation of gathering information on maritime traffic in the context of the invention;

FIG. 3, an example of the tagging of a ship in a maritime-traffic area by the means of the invention;

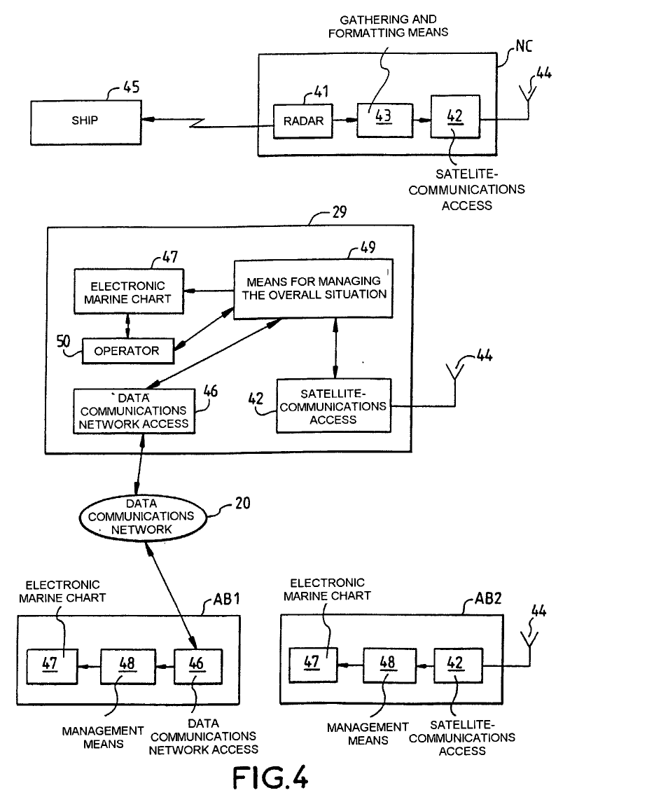

FIG. 4, a possible embodiment of a device according to the invention.

FIG. 1 illustrates the possible stages of the method according to the invention. The method includes two main stages, a first stage 1 of deriving the overall situation of the maritime traffic, and a second stage 2 of collective interpretation of this overall situation.

The first stage 1 includes a first sub-stage 101 of periodic gathering of the local traffic situations and, for example, a second sub-stage 102 of management of the overall traffic situation.

The second stage 2 includes a first sub-stage 201 of distribution of the required maritime-traffic situation to subscribers, a second sub-stage 202 of presentation of the extracted information to the subscriber, and a third sub-stage 203 of a posteriori management of the maritime traffic. Examples of embodiment of these stages and sub-stages are described in what follows.

The first stage therefore includes a first sub-stage 101 of periodic gathering of the local maritime-traffic situations. The invention in particular uses the fact that, nowadays, many ships are equipped with radar and can thus have a view of all the boats and ships present in their vicinity. At the present time, this knowledge of the traffic unfortunately remains local, that is to say does not leave the ship carrying a radar. In this first stage 101, the radar situations produced on board the ships and present in the area to be surveyed are gathered. These ships which possess a radar and which supply this traffic information will be called cooperating ships in what follows. In addition to this information gathered on the cooperating ships is added information gathered conventionally by the coastal surveillance centers.

FIG. 2 illustrates a traffic-information gathering situation carried out in the first stage. This figure presents a surveillance area 21, situated between the two dashed lines, along a coast 22. By way of example, three land-based surveillance centers are represented, CT1, CT2, CT3, situated on land and each having a given radar coverage 23, 24, 25, and three cooperating ships NC1, NC2, NC3 having a given radar coverage 26, 27, 28. Four unknown ships NI1, NI2, NI3, NI4, are additionally represented, still by way of example. A first unknown ships NI1 is detected within the radar coverage of a first land-based surveillance center CT1. A second unknown ship NI2 is detected by a first cooperating ship NC1. A third unknown ship NI3 is detected by the second land-based surveillance center CT2. Finally, a fourth unknown ship NI4 is detected by the second cooperating ship NC2 and by the third cooperating ship NC3.

The traffic information thus gathered by the surveillance centers land-based and by the cooperating ships are routed, for example periodically, to a central concentrator 29 in order, at that level, to have available an image of traffic in the area which is as complete and precise as possible. The data are transmitted to this central concentrator 29 via an appropriate medium. This center 29 furthermore includes means for storing each local traffic situation transmitted by a cooperating ship or by a land-based surveillance center.

The coverage of the area to be surveyed may, for example, be supplemented by the use of detection systems in aircraft temporarily overflying this area, which makes it possible to enhance the identification of the traffic elements, as well as the monitoring thereof.

The data gathered are, for example, formatted by taking account especially of the sampling time-stamp, of the position of the ship and of the identity supplied by the local operator.

This first stage thus makes it possible to compile the overall maritime-traffic situation in a vast area on the basis especially of the local traffic information held by each of the cooperating ships regularly passing through this area. This traffic information originates from radar equipment on board the ships. One advantage of the invention is that it particularly allows tracking of ships deliberately wishing to be discreet, that is to say non-cooperating, and does this in a near-continuous way.

The periodic gathering of the local traffic situations is followed by a stage 102 of management of the overall traffic situation. This stage is implemented essentially within the central concentrator 29. This center, which in fact manages the surveillance of the whole of the area, will be called main maritime-traffic surveillance center in what follows.

In this stage, the position of each ship is readjusted with the last data gathered. The data received may, for example, be supplemented with the identity, cargo or destination information supplied by the cooperating ships. The overall situation of the traffic may further be supplemented by environmental information such as meteorological information, information relating to accidents or information relating to the availability of port facilities, for example. In point of fact, the current state of the art with radars equipping ships makes it possible to obtain a certain depth of environmental information. These radars furthermore make it possible to determine the surface area and the silhouette of the ships detected, to carry out a classification thereof, to obtain the speed and the direction of the wind, the state of the sea and of the waves as well as cloud density. It should be noted, however, that not all ships are equipped with such high-performance radars, especially for reasons of cost. In this case, they transmit only their position and their identification, for example.

The position of each ship is, moreover, kept up to date between two gathering operations by extrapolation means which are based on the previous trajectories of each ship and also with respect to other information. By way of example, FIG. 3 illustrates a tracking of the position of an unknown ship by the main surveillance center 29. The surveillance area is the same as that of FIG. 2. The tracking is carried out on an unknown ship NI4. Its successive detected positions are represented by a first star 31, a second star 32 and a third star 33. The position of the ship NI4 is thus detected successively by the third cooperating ship NC3, by the second cooperating ship NC2 and by the second land-based center CT2, which transmit their information to the main surveillance center 29. The tracking illustrated by FIG. 3 may be supplemented and refined by information such as the time at which the ship NI4 left port, the situation of which coincides, for example, with the third land-based surveillance center CT3, the navigation plan and the loading of the ship. All this information can be supplied by the third surveillance center CT3. The tracking of the ship NI4 herein does not demand any collaboration on its part. This may be of particularly great benefit in the case of customs or police operations.

The method according to the invention thus makes it possible to carry out effective surveillance in a given area which may be a vast area particularly because of the contribution from cooperating ships. The detection and classification of the ships are carried out especially by the detections and classifications of the data supplied by the land-based centers and by the cooperating ships entering this area, as well as the identification and the tracking of the position of the ships.

The main surveillance center 29 includes, for example, means for periodically archiving the overall traffic situation, especially for the purposes of a posteriori interpretation.

After interpreting the overall situation of the maritime traffic, the method according to the invention includes, for example, a series of stages 201, 202, 203 allowing the collective interpretation of this overall situation.

A first stage 201 consists especially in distributing the required maritime-traffic situation to subscribers, that is to say a traffic situation which is of interest or of use to these subscribers. These subscribers are navigators, for example, maritime-traffic controllers or fleet operators. To this end, the main surveillance center 29 broadcasts the overall maritime-traffic situation, via the appropriate media. It picks up and decrypts, for example in advance, information supplied by the subscribers in order to broadcast to each subscriber only the information to which it is entitled. There is thus a filtering of the information as a function of the subscribers. This filtering may also be done by means equipping the subscribers.

A second stage 202 consists especially in presenting the information extracted from the preceding filtering to each subscriber. The central concentrator allows especially each subscriber to view the maritime-traffic situation, this situation being combined with local cartography relative to the subscriber. It particularly communicates the data specific to each ship selected, such as the identity, the route, the speed, the departure and the destination ports or the type of cargo, for example. It alerts the subscriber in the event of a dangerous situation being detected, and proposes an optimum plan in the organization of help in the event of an accident.

The invention thus makes it possible to give all the navigators and controllers of the maritime traffic visibility over the traffic within a vast area 21, out of all proportion to that provided by the facilities usually employed, by periodically broadcasting the overall situation of the traffic and by allowing all or some of the traffic to be viewed. One advantage of the invention is particularly that it provides a dedicated channel for raising personalized alarms originating from the main surveillance center 29.

A third stage 203 may be provided for, for example. This stage consists in managing the maritime traffic a posteriori. To do that, the overall situation is periodically archived. On the basis of the data thus archived, the a posteriori management of the traffic may, for example, consist in reconstituting the route of a ship, in producing statistical traffic reports or even in predicting the traffic.

FIG. 4, via a block diagram, illustrates a device for implementing the method according to the invention. Such a device includes at least one network of cooperating ships NC passing through the area 21 to be surveyed and the main surveillance center 29. To these two elements are advantageously added, for example, the land-based surveillance centers usually used. Aircraft passing through the area to be surveyed may possibly be integrated into the device. The above-mentioned facilities especially allow the gathering of the maritime-traffic information.

In order to carry out its function, a cooperating ship NC is equipped, for example, with a maritime surveillance radar 41, with a satellite-communications access terminal 42 and with means 43 for gathering and formatting the information supplied by the on-board radar 41 or, more generally, the navigation system. In particular, these means 43 pick up the data from the radar situation derived by the maritime-surveillance radar 41, put these data into an appropriate form, taking account especially of the sampling time-stamp, of the position of the cooperating ship and of the identity of the ships detected which is supplied by the local operator, on board the cooperating ship. These means transmit the traffic information, for example in encrypted form, to the main surveillance center 29, via the satellite-communications access terminal. This terminal, to this end, is linked to an antenna 44. A ship 45 detected by a cooperating ship is itself a cooperating or non-cooperating ship.

A device according to the invention further includes, for example, subscribers AB1, AB2. A subscriber may or may not be a cooperating ship. It may also be an operator of a fleet of ships or even a land-based control center CT1, CT2, CT3 for control of maritime traffic. It is particularly equipped with the facilities set out in what follows. If the subscriber AB2 is a ship, it includes, for example, a satellite-communications access terminal 42. If the subscriber AB1 is a fleet operator or a land-based control center, it includes, for example, a terminal 46 for access to a data communications network 20, for example the Internet. Via these terminals 42, 46, the subscriber receives the information broadcast by the main surveillance center 29. A subscriber includes, for example, an electronic marine chart 47 on which the local operator can carry out all the traditional surveillance operations. It finally includes means 48 for managing the local situation of the maritime traffic. The input of these means is linked to the access means 42, 46, their output being, for example, linked to the electronic marine chart 47. These means 48 include, for example, the following functions:

receiving, via the satellite-communications access terminal 42 or the terminal 46 for access to the data communications network, the information on the overall maritime-traffic situation broadcast by the main surveillance center 29;

picking up and decrypting the information and filtering that information to which the subscriber is not entitled.

visually displaying the maritime-traffic situation superimposed on a marine chart by way of the electronic marine chart 47;

communicating to the operator the data specific to each selected ship, such as the identity, the route, the speed, the departure and destination ports, the type of cargo or even the route followed, for example;

alerting the subscriber in the event of a dangerous situation being detected;

proposing an optimum plan in organizing help in the event of accidents;

periodically archiving the local information.

The main surveillance center 29 includes, for example, the means described in what follows. It thus includes a satellite-communications access terminal 42, associated with an antenna 44 for exchanging data with the ships, especially with the cooperating ships and subscribers. It includes a terminal 46 for access to the data communications network for exchanging data with the land-based participants, especially the information gatherers and the subscribers. It further includes, for example, an electronic marine chart 47 on which an operator can carry out all the traditional navigation operations.

The main surveillance center 29 further includes means for managing the overall situation of the maritime traffic 49 which are linked to the access means 42, 46 and, for example, to the electronic marine chart 47. These means gather the traffic information from the cooperating ships, receiving them via the satellite-access terminal. With this information having been gathered, it especially provides for management of the overall situation of the maritime traffic via the following functions:

readjusting the position of each ship with the latest data gathered;

keeping the position of each ship up to date, between two gathering operations, especially using as a basis the previous trajectories and other information relating, for example, to the destination, but also using environmental information as a basis;

supplementing the data from each ship with the identity, cargo or destination information, for example;

supplementing the overall situation with environmental information such as information relating to meteorology, to accidents or to availability of port facilities, for example;

periodically archiving the overall situation for the purposes of a posteriori interpretation;

visually displaying the maritime-traffic situation superimposed on the marine chart by virtue of the electronic marine chart;

communicating to an operator 50 the data specific to each ship selected, such as the data relating to its identity, to its route, to its speed, to its departure and destination ports, to its type of cargo or to the route it has followed, for example;

alerting the operator 50 in the event of a dangerous situation being detected;

proposing an optimum plan in the organization of help in the event of accidents.

The management means 49 of the main center 29 furthermore broadcast the information relating to the global situation of the maritime traffic to the management means 43 equipping the subscribers, via the satellite-communications means 42, 44 or via the communications means 46 of the data communications network 20. This information is broadcast in encrypted form, for example.

The management means 49 of the main center can also carry out a posteriori management of the maritime traffic, for example by periodically archiving the overall situation, by producing statistical traffic reports or by predicting the traffic.

A device according to the invention therefore includes, for example, and network of elements for gathering information on the maritime traffic. These elements are, for example, land-based surveillance centers, of traditional type, and cooperating ships NC equipped with gathering and formatting means 43, the functions of which have been described above. These gathering means 43 use the information from the navigation equipment of the cooperating ships, especially their radar. The additional equipment necessary for a cooperating ship to carry out its task of maritime-traffic information gathering consists essentially of the gathering means 43, since the navigation equipment such as the radar are already used elsewhere for the conventional applications. Among these pieces of navigation equipment, there is generally also satellite-communications access means 42, 44 used especially by the GPS systems. The gathering means 43 may, if appropriate, also equip aircraft fitted with radar and regularly overflying the area to be surveyed. These aircraft are then cooperating and have the same function as a cooperating ship.

In parallel with this network of participants in the gathering of maritime-traffic information, there exists a network of subscribers, for example, possibly being participants in the information gathering or otherwise. These subscribers, which are therefore ships, maritime-traffic control centers or fleet operators, for example, include means 48 for local management of the maritime traffic on the basis of the information supplied by the main center 29. These management means 48 essentially further constitute the additional equipment for accessing the information, to the extent that the subscribers moreover use, for their traditional applications, the satellite-communications access means to the means for access to a data communications network.

Finally, the coordination, the broadcasting and the central management of all the maritime-traffic information is undertaken by the main surveillance center 29 on the basis essentially of its means for managing the overall situation of the maritime traffic 49, the latter particularly exchanging information with the gathering means 43 of the cooperating elements and with the means for managing the local situation 48 of the subscribers.

The gathering 43 or management 48, 49 means are produced on the basis of processors, memory circuits and interfaces. Their hardware aspect is conventional. They may, for example, be integrated into on-board computers or land-based processing systems. They do not demand any complex or expensive hardware features. Hence, an economic advantage of the invention emerges here. The invention in point of fact allows effective surveillance over a vast area with limited and inexpensive additional overall equipment.

1. A method of surveillance of maritime traffic, the surveillance being carried out in a given area (21), characterized in that it includes at least:
a first stage (101) of the periodic gathering of maritime-traffic information by cooperating ships (NC, NC1, NC2, NC3) passing through the area (21), on the basis of their navigation equipment, the ships sending the information to a main maritime-surveillance center (29);
a second stage (102) of managing the overall traffic situation carried out by the main center on the basis of the data gathered by the cooperating ships, each ship thus providing a local traffic situation.

2. The method as claimed in claim 1, characterized in that the information gathered is supplied by the onboard radars of the ships.

3. The method as claimed in any one of the preceding claims, characterized in that the information is also gathered by maritime-surveillance centers (CT1, CT2, CT3) situated on land.

4. The method as claimed in any one of the preceding claims, characterized in that the overall situation is archived periodically.

5. The method as claimed in any one of the preceding claims, characterized in that each local traffic situation is archived.

6. The method as claimed in any one of the preceding claims, characterized in that, in addition to the position of a detected ship (NI4), the cooperating ships supply the main surveillance center (29) with environmental information.

7. The method as claimed in any one of the preceding claims, characterized in that it includes a stage (2) of collective interpretation of the overall maritime-traffic situation in which the main surveillance center (29) distributes the required maritime-traffic situation to subscribers.

8. The method as claimed in claim 7, characterized in that the subscribers are ships, maritime-traffic controllers or fleet operators.

9. The method as claimed in any one of the preceding claims, characterized in that the gathering of the maritime-traffic information is carried out furthermore by an aircraft passing through the area to be surveyed.

10. A device for maritime surveillance, the surveillance being carried out in a given area (21), characterized in that includes at least one network of cooperating ships (NC, NC1, NC2, NC3) and a main maritime-surveillance center, a cooperating ship (NC) including at least:
means (43) for gathering and formatting maritime-traffic information supplied by the navigation system;
means (42, 44) for routing the formatted information to the main surveillance center (29);
the main surveillance center including at least:
means (49) for the overall management of the maritime traffic on the basis of the data transmitted by the cooperating ships;
means (42, 44) for communicating with the cooperating ships.

11. The device as claimed in claim 10, characterized in that it further includes, equipping the subscribers (AB1, AB2), means (48) for local management of the maritime traffic and communication means (42, 44, 46, 47) allowing the local-management means (48) to receive required traffic information from the means for overall management of the maritime traffic (49).

12. The device as claimed in either of claims 10 and 11, characterized in that the gathering means (43) pick up the data on the radar situation derived by a maritime-surveillance radar equipping the cooperating ship and putting these data into a suitable form.

13. The device as claimed in any one of the preceding claims, characterized in that the data gathered are routed to the main surveillance center via a satellite-communications access terminal (42).

14. The device as claimed in claim 11, characterized in that, a subscriber (AB2) being a ship, its means for managing the local situation (48) receive the maritime-traffic information via a satellite-communications access terminal (42).

15. The device as claimed in claim 11, characterized in that, a subscriber (AB1) being on land, its means for managing the local situation (48) receive the maritime-traffic information via a terminal (46) for access to a data communications network (20).

16. The device as claimed in any one of claims 10 to 15, characterized in that an electronic chart is linked to the means for managing the overall maritime situation (49) in order to visually display the overall maritime-traffic situation.

17. The device as claimed in any one of claims 11 to 16, characterized in that, at the subscribers, an electronic chart is linked to the means for managing the local maritime situation (49) in order to visually display the local maritime-traffic situation relating to the subscriber.

18. The device as claimed in any one of claims 11 to 17, characterized in that the means for managing the local maritime situation (48) includes means for filtering the data to which the subscriber has no right.

19. The device as claimed in any one of claims 11 to 18, characterized in that the means for managing the overall maritime situation (49) include means for encrypting the information which they broadcast, the means for managing the local maritime situation (48) including means for decrypting this information.
